(19) United States
(12) Patent Application Publication
(10) Pub. No.: US 2026/0173019 A1
(43) Pub. Date: Jun. 18, 2026

(54) INDOOR LOCALIZATION METHOD AND APPARATUS FOR PERFORMING SAME

(71) Applicant: SAMSUNG ELECTRONICS CO., LTD., Suwon-si (KR)

(72) Inventors: Jusik YUN, Suwon-si (KR); Gibeom KIM, Suwon-si (KR); Sangsoo LEE, Suwon-si (KR); Sunkee LEE, Suwon-si (KR); Junsu CHOI, Suwon-si (KR); Kwanghoon HAN, Suwon-si (KR)

(21) Appl. No.: 19/530,812

(22) Filed: Feb. 5, 2026

Related U.S. Application Data
(63) Continuation of application No. PCT/KR2024/010135, filed on Jul. 16, 2024.

(30) Foreign Application Priority Data
Sep. 5, 2023 (KR) 10-2023-0117461
Oct. 16, 2023 (KR) 10-2023-0137707

(51) Int. Cl. H04W 64/00; H04B 17/318; H04W 4/33

(52) U.S. Cl. CPC H04W 64/00; H04B 17/318; H04W 4/33

(57) ABSTRACT

An indoor localization method, may comprise: receiving, from an external electronic device, a wireless signal including a first frequency signal and a second frequency signal; determining that the electronic device is located in an indoor space on the basis of a received signal strength indication (RSSI) of the wireless signal and first reference data; and outputting indoor location information of the electronic device on the basis of an RSSI difference between the first frequency signal and the second frequency signal and second reference data, in response to determining that the electronic device is located in the indoor space.

### CROSS-REFERENCE TO RELATED APPLICATIONS

This application is a continuation of International Application No. PCT/KR2024/010135 designating the United States, filed on Jul. 16, 2024, in the Korean Intellectual Property Receiving Office and claiming priority to Korean Patent Application Nos. 10-2023-0117461, filed on Sep. 5, 2023, and 10-2023-0137707, filed on Oct. 16, 2023, in the Korean Intellectual Property Office, the disclosures of each of which are incorporated by reference herein in their entireties.

### BACKGROUND

### Field

The disclosure relates to an indoor localization method and an apparatus for performing the same.

### Description of Related Art

A wireless local area network (WLAN) may be a network that connects devices in a local area (e.g., a home) using wireless communication.

The WLAN may be used to detect a location of a target (e.g., a person, a device) as well as for data communication. For example, communication technologies such as Wi-Fi, Bluetooth, or Ultra-wideband (UWB) may be used for an indoor localization system.

The above information may be presented as the related art to help with the understanding of the disclosure. No assertion or determination is made as to whether any of the above is applicable as a prior art related to the disclosure.

A representative technique used in a wireless signal based indoor localization system is a received signal strength indicator (RSSI) technique. In order to accurately detect a location of a target, an improved indoor localization algorithm may be needed.

### SUMMARY

An electronic device according to an example embodiment may include: at least one processor, comprising processing circuitry, and memory storing instructions, wherein at least one processor, individually and/or collectively, may be configured to execute the instructions and to cause the electronic device to: receive a wireless signal including a first frequency signal and a second frequency signal from an external electronic device; determine that the electronic device is located in a specific indoor space based on a received signal strength indicator (RSSI) of the wireless signal and first reference data; and output indoor location information of the electronic device based on an RSSI difference between the first frequency signal and the second frequency signal and second reference data, in response to determining that the electronic device is located in the specific indoor space.

A method of operating an electronic device according to an example embodiment may include: receiving a wireless signal including a first frequency signal and a second frequency signal from an external electronic device; determining that the electronic device is located in a specific indoor space based on an RSSI of the wireless signal and first reference data; and outputting indoor location information of the electronic device based on an RSSI difference between the first frequency signal and the second frequency signal and second reference data, in response to determining that the electronic device is located in the specific indoor space.

According to an example embodiment, a non-transitory computer-readable storage medium storing one or more computer programs may include instructions that, when executed by at least one processor cause an electronic device to perform the method.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating RSSI according to various embodiments.

FIG. 2 is a diagram illustrating an example RSSI fingerprint according to various embodiments.

FIGS. 3 and 4 are a diagram and graph illustrating a correlation between frequency and attenuation according to various embodiments.

FIGS. 5 and 6 are a diagram and graph illustrating an example indoor localization algorithm according to various embodiments.

FIG. 7 is a flowchart illustrating an example reference data collection process according to various embodiments.

FIGS. 8 and 9 are a flowchart and signal flow diagram illustrating an example indoor localization process according to various embodiments.

FIG. 10 is a flowchart illustrating an example transmit power adjustment process according to various embodiments.

FIG. 11 is a diagram illustrating an example of an indoor localization system according to various embodiments.

FIG. 12 is a block diagram illustrating an example electronic device in a network environment according to various embodiments.

FIG. 13 is a flowchart illustrating an example operation of an electronic device according to various embodiments.

### DETAILED DESCRIPTION

Hereinafter, various example embodiments will be described in greater detail with reference to the accompanying drawings. When describing the various example embodiments with reference to the accompanying drawings, like reference numerals refer to like components and a repeated description related thereto may not be provided.

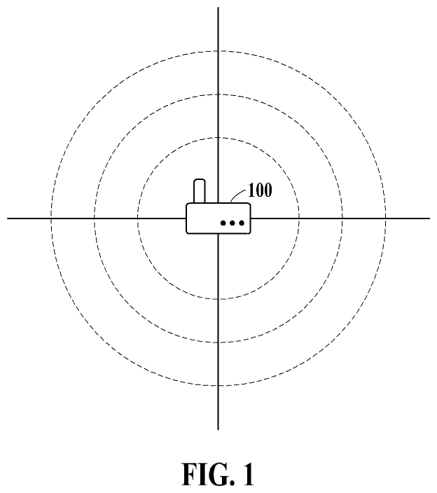

FIG. 1 is a diagram illustrating an example RSSI according to various embodiments.

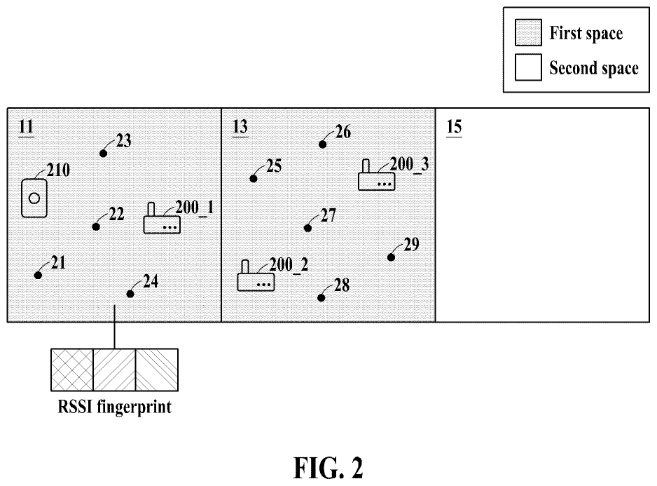

Referring to FIG. 1, according to an embodiment, an electronic device 100 (e.g., an access point (AP)) may emit a wireless signal (e.g., a Bluetooth (BT) signal, a Wi-Fi signal) to a space surrounding the electronic device 100. A received signal strength indicator (RSSI) of the wireless signal may decrease as a distance from the electronic device 100 increases. An RSSI fingerprint for (or in) a surrounding indoor space of the electronic device 100 may be generated using such a correlation between the distance from the electronic device 100 and the RSSI. The RSSI fingerprint will be described in detail with reference to FIG. 2.

FIG. 2 is a diagram illustrating an example RSSI fingerprint according to various embodiments.

Referring to FIG. 2, according to an embodiment, one or more devices capable of transmitting and receiving a wireless signal may be located in indoor spaces. For example, a plurality of indoor spaces 11 to 15 may exist, a station (e.g., a SmartThings station) and an access point (AP) 200_1 may be located in the indoor space 11, and APs 200_2, 200_3 may be located in the indoor space 13.

According to an embodiment, a station 210 may generate RSSI fingerprint information for an indoor space based on an RSSI of a wireless signal (e.g., a BT signal, a Wi-Fi signal) received from each of APs 200_1 to 200_3. For example, the station 210 may generate RSSI fingerprint information (or an RSSI fingerprint map) corresponding to reference points 21, 22, 23, 24, 25, 26, 27, 28 and 29 in the first spaces 11, 12. In the disclosure, a first space indicates an indoor space in which reference data related to RSSI (e.g., first reference data and/or second reference data) is generated, and a second space may indicate an indoor space in which reference data is not generated. In the disclosure, reference data may indicate RSSI-related data collected in advance during a predetermined period (e.g., a training period) for indoor localization. The first reference data may include RSSI fingerprint information for an indoor space, and the second reference data may include information on a difference between an RSSI of a low-frequency signal and an RSSI of a high-frequency signal for an indoor space.

According to an embodiment, the RSSI fingerprint information may be used to detect a location of an electronic device (not shown) (e.g., a mobile device such as a smartphone) in the indoor spaces 11 to 15. The electronic device (not shown) may obtain an RSSI fingerprint (or an RSSI value) corresponding to the current location, and may compare the obtained RSSI fingerprint to first reference data collected in advance. The electronic device (not shown) may identify a reference point most similar to the RSSI fingerprint obtained from the first reference data. The electronic device (not shown) may detect the current location of the electronic device (not shown) based on the identified reference point.

According to an embodiment, in order to accurately detect the current location of the electronic device (not shown), additional information in addition to the RSSI fingerprint information may be needed. For example, it may be assumed that the electronic device (not shown) is located in a second space 15. In this case, the electronic device (not shown) may determine the current location of the electronic device (not shown) as an indoor space (e.g., the indoor space 13) in which first reference data most similar to an RSSI fingerprint obtained in the second space 15 is collected. That is, an indoor space localization process based only on RSSI fingerprint information may not accurately detect the current location of the electronic device (not shown) when the electronic device (not shown) is located in the second space 15 in which RSSI fingerprint information is not collected in advance.

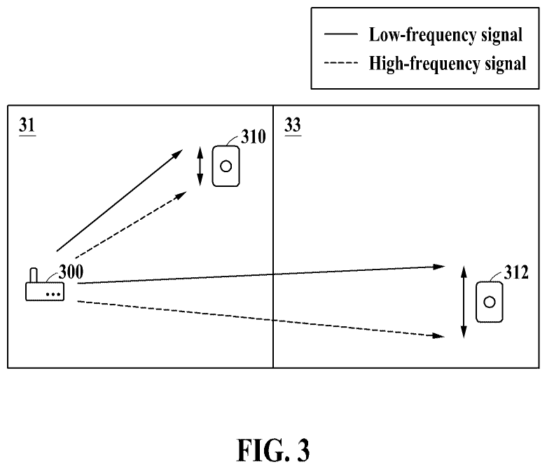

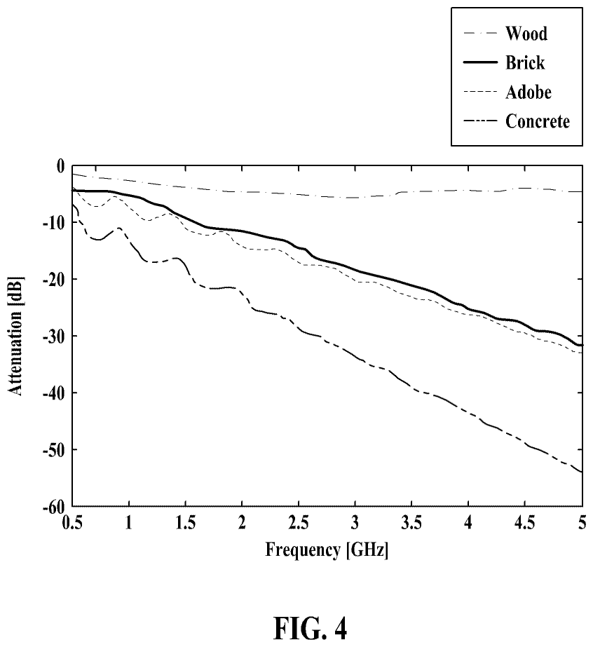

FIGS. 3 and 4 are a diagram and a graph illustrating example correlation between frequency and attenuation according to various embodiments.

Referring to FIGS. 3 and 4, according to an embodiment, a wireless signal emitted from a signal source (e.g., an AP 300) may be attenuated as a distance from the signal source (e.g., the AP 300) increases. An attenuation rate of the wireless signal may be determined based on a frequency of the wireless signal and a type of obstacle. For example, an indoor environment may be assumed in which an indoor space 31 and an indoor space 33 are separated by a wall (e.g., a concrete wall), the AP 300 and a station 310 are located in the indoor space 31, and a station 312 is located in the indoor space 33. The AP 300 may emit a high-frequency signal (e.g., a 5 GHz wireless signal) and a low-frequency signal (e.g., a 2.4 GHz wireless signal). In the disclosure, the high-frequency signal and the low-frequency signal indicate wireless signals of different frequencies, and should not be interpreted as indicating a wireless signal of a specific frequency. Although FIG. 3 illustrates that the high-frequency signal and the low-frequency signal are emitted from a single AP 300, different devices may emit the high-frequency signal and the low-frequency signal, respectively.

According to an embodiment, since the high-frequency signal is affected by an obstacle more than the low-frequency signal, a difference between an RSSI of the high-frequency signal and an RSSI of the low-frequency signal measured by the station 312 may be greater than a difference between an RSSI of the high-frequency signal and an RSSI of the low-frequency signal measured by the station 310. For example, an RSSI of a low-frequency signal, an RSSI of a high-frequency signal, and a difference between an RSSI of a high-frequency signal and an RSSI of a low-frequency signal may be expressed as Equations 1 to 3 below. In Equations 1 to 3, ‘low’ may represent a low-frequency signal, ‘high’ may represent a high-frequency signal, ‘tx_power’ may represent transmit power, ‘pathloss’ may represent path loss between a transmitting antenna and a receiving antenna, ‘tx_antenna gain’ may represent a gain of a transmitting antenna, and ‘rx_antenna gain’ may represent a gain of a receiving antenna.

RSSI_low=tx_power_low−pathloss_low+tx_antenna gain_low+rx_antenna gain_low [Equation 1]

RSSI high=tx_power_high−pathloss_high+tx_antenna gain high+rx_antenna gain high [Equation 2]

RSSI_diff=pathloss_high−pathloss_low+(tx_power_high−tx_power_low) [Equation 3]

Referring to Equation 3, when transmit power of the low-frequency signal and transmit power of the high-frequency signal are identical, a difference between an RSSI of the low-frequency signal and an RSSI of the high-frequency signal may be determined based on the path loss.

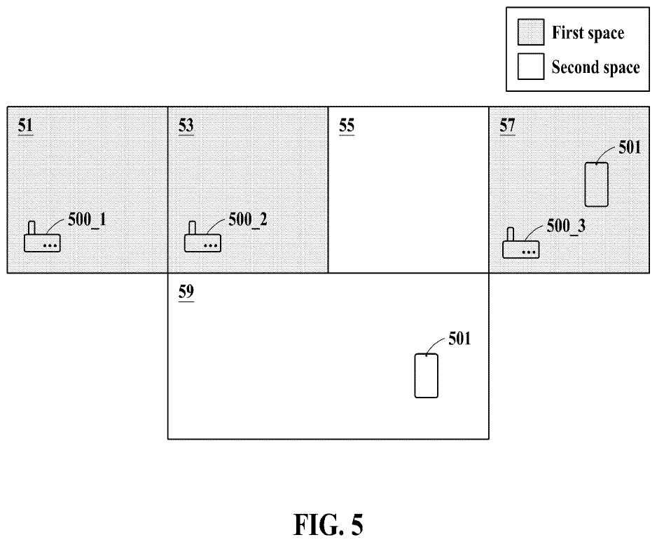

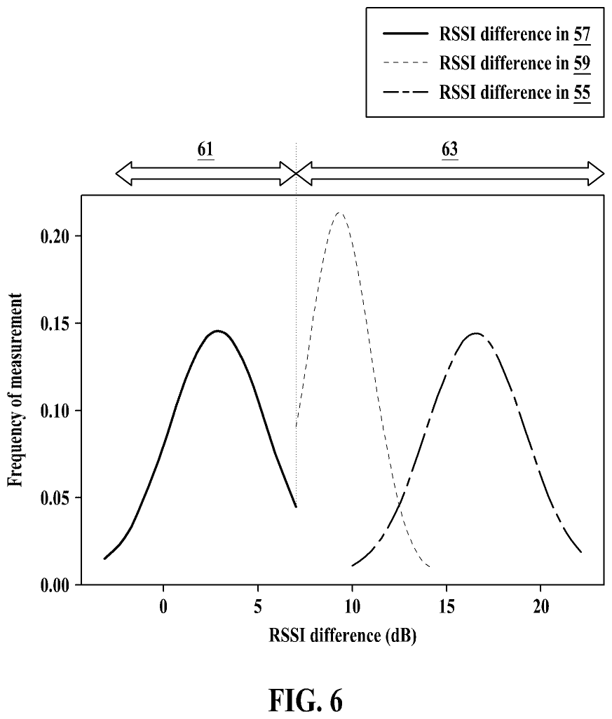

FIGS. 5 and 6 are a diagram and a graph illustrating an example indoor localization process according to various embodiments. FIG. 5 is a diagram illustrating an example of an indoor environment for explaining an indoor localization process according to various embodiments, and FIG. 6 may be a graph illustrating a difference between an RSSI of a high-frequency signal and an RSSI of a low-frequency signal measured in an indoor space according to various embodiments.

Referring to FIGS. 5 and 6, according to an embodiment, a plurality of indoor spaces 51 to 59 may exist, some 51, 53, 57 of the plurality of indoor spaces 51 to 59 may be first spaces, and the others 55, 59 may be second spaces. For example, first reference data and second reference data for the indoor spaces 51, 53, 57 may exist, and first reference data and second reference data for the indoor spaces 55, 59 may not exist.

According to an embodiment, the first reference data may include RSSI fingerprint information generated from wireless signals received from electronic devices (e.g., wireless signal emitting devices 500_1, 500_2 and 500_3 such as APs) in the plurality of indoor spaces 51 to 59.

According to an embodiment, the second reference data may include information on an RSSI difference between a low-frequency signal and a high-frequency signal received from a predetermined electronic device (e.g., a reference device) corresponding to an indoor space (e.g., each of the first spaces 51, 53, 57) among the electronic devices (e.g., the wireless signal emitting devices 500_1 to 500_3 such as APs) in the plurality of indoor spaces 51 to 59. For example, the second reference data may be collected based on a low-frequency signal and a high-frequency signal received from an electronic device (e.g., an AP) located in a corresponding indoor space. For example, second reference data for the indoor space 51 may include information on an RSSI difference between a low-frequency signal and a high-frequency signal received from an electronic device 500_1 located in the indoor space 51. In order to collect the second reference data, a station (not shown) may identify an electronic device in a corresponding space based on an identifier (ID) (e.g., a service set identifier (SSID), a basic service set identifier (BSSID)) of the electronic devices (e.g., the wireless signal emitting devices 500_1 to 500_3 such as APs) in the plurality of indoor spaces 51 to 59. When locations of the electronic devices 500_1 to 500_3 cannot be identified using the ID, the station (not shown) may determine an electronic device having the smallest RSSI difference between a received low-frequency signal and a received high-frequency signal as a reference device corresponding to the corresponding space. For example, when the second reference data is collected by a station (e.g., a SmartThings station) installed in the indoor space 57, the station may generate second reference data for the indoor space 57 as in Equation 4 below.

RSSI_diff_space ID=[device ID,x,y] [Equation 4]

In Equation 4, ‘space ID’ may represent an ID of the indoor space 57, and ‘device ID’ may represent an ID of a reference device (e.g., the electronic device 500_3) corresponding to the indoor space 57. A ‘device ID’ of a station located in the indoor space 57 may be used instead of ‘space ID’. ‘x’ may represent a minimum value (e.g., 0 dB) of an RSSI difference between a low-frequency signal and a high-frequency signal received from the reference device (e.g., the electronic device 5001), and ‘y’ may represent a maximum value (e.g., 7 dB) of the RSSI difference.

According to an embodiment, an electronic device 501 (e.g., an indoor localization device such as a smartphone) may perform an indoor localization process when the electronic device 501 is located in any one indoor space among the plurality of indoor spaces 51 to 59.

According to an embodiment, when the electronic device 501 is located in a first space, the electronic device 501 may perform the indoor localization process. Hereinafter, the disclosure will be described assuming that the electronic device 501 is located in the first space 57. The electronic device 501 may compare an RSSI fingerprint currently obtained in the first space 57 to first reference data collected in advance. The electronic device 501 may determine the current location of the electronic device 501 as the first space 57 based on the comparison result. The electronic device 501 may re-determine the current location of the electronic device 501 based on second reference data, in response to the current location of the electronic device 501 being determined as the first space 57. The electronic device 501 may compare an RSSI difference between a high-frequency signal and a low-frequency signal currently received from a reference device (e.g., the electronic device 5003) corresponding to the first space 57 to second reference data for the first space 57. Since the electronic device 501 is located in the first space 57, the currently obtained RSSI difference may correspond to the second reference data for the first space 57 (e.g., an RSSI difference range 61 for the first space 57). For example, the currently obtained RSSI difference may be less than a maximum difference value of RSSI (e.g., 7 dB) included in the second reference data for the first space 57. The electronic device 501 may output location information (e.g., a user interface) indicating that the electronic device 501 is located in the first space 57 when the currently obtained RSSI difference corresponds to the second reference data for the first space 57.

According to an embodiment, when the electronic device 501 is located in a second space, the electronic device 501 may perform the indoor localization process. Hereinafter, it will be described assuming that the electronic device 501 is located in the second space 59. The electronic device 501 may compare an RSSI fingerprint currently obtained in the second space 59 to first reference data collected in advance. The electronic device 501 may determine the current location of the electronic device 501 based on the comparison result. Since the first reference data for the second space 59 is not collected, the electronic device 501 may determine the current location of the electronic device 501 based on first reference data for the first spaces 53, 57 around the second space 59. Hereinafter, it will be described assuming that a currently obtained RSSI fingerprint (RSSI value) is more similar to first reference data for the first space 57 than to first reference data for the first space 53. The electronic device 501 may determine the current location of the electronic device 501 as the first space 57 based on the comparison result. The electronic device 501 may re-determine the current location of the electronic device 501 based on second reference data, in response to the current location of the electronic device 501 being determined as the first space 57. The electronic device 501 may compare an RSSI difference between a high-frequency signal and a low-frequency signal currently received from a reference device (e.g., the electronic device 5003) corresponding to the first space 57 to second reference data for the first space 57. Since the actual current location of the electronic device 501 is the second space 59 rather than the first space 57, the currently obtained RSSI difference may not correspond to the second reference data for the first space 57 (e.g., the RSSI difference range 61 for the first space 57). For example, the currently obtained RSSI difference may be within an RSSI difference range 63 greater than a maximum difference value of RSSI (e.g., 7 dB) included in the second reference data for the first space 57. The electronic device 501 may output location information (e.g., a user interface) indicating that the current location of the electronic device 501 cannot be detected (or determined) when the currently obtained RSSI difference does not correspond to the second reference data for the first space 57. The electronic device 501 may output location information indicating that the electronic device 501 is located in any one space among the second spaces 55, 59, alone or together with the location information indicating that the current location of the electronic device 501 cannot be detected.

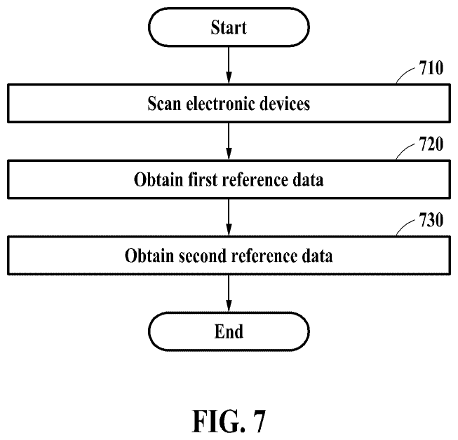

FIG. 7 is a flowchart illustrating an example reference data collection process according to various embodiments.

Referring to FIG. 7, according to an embodiment, an electronic device (e.g., the station 210 of FIG. 2, the stations 310, 312 of FIG. 3) may perform a reference data collection process. Operations 710 to 730 may be performed sequentially, but the disclosure is not limited thereto. For example, two or more operations (e.g., operations 720 and 730) may be performed in parallel. Operations 710 to 730 may be substantially identical to the operations of the station described with reference to FIGS. 2 to 6. Accordingly, a repeated description thereof will be omitted.

In operation 710, a station located in a plurality of indoor spaces (e.g., the indoor spaces 51 to 59 of FIG. 5) may scan one or more electronic devices (e.g., wireless signal emitting devices such as the APs 500_1 to 500_3 of FIG. 5) located in the plurality of indoor spaces 51 to 59.

In operation 720, the station may collect (or obtain) first reference data (e.g., RSSI fingerprint information) for the first spaces (e.g., the first spaces 51, 53, 57 of FIG. 5) based on wireless signals received from the scanned electronic devices.

In operation 730, the station may obtain second reference data (e.g., RSSI difference information between a low-frequency signal and a high-frequency signal) for each of the first spaces (e.g., the first spaces 51, 53, 57 of FIG. 5) based on a high-frequency signal and a low-frequency signal received from a reference device corresponding to each of the first spaces (e.g., the first spaces 51, 53, 57 of FIG. 5).

According to an embodiment, the station may transmit the first reference data and the second reference data to an electronic device (e.g., an indoor localization device such as the electronic device 501 of FIG. 5).

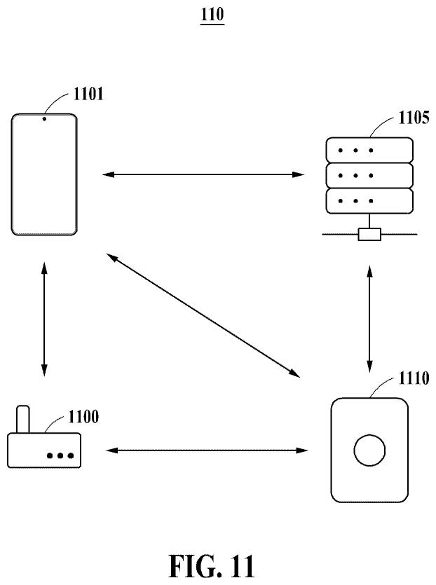

According to an embodiment, when a server managing a station exists (e.g., a station server of FIG. 11), the station may transmit reference data (e.g., the first reference data and the second reference data) to a station server (e.g., the station server of FIG. 11).

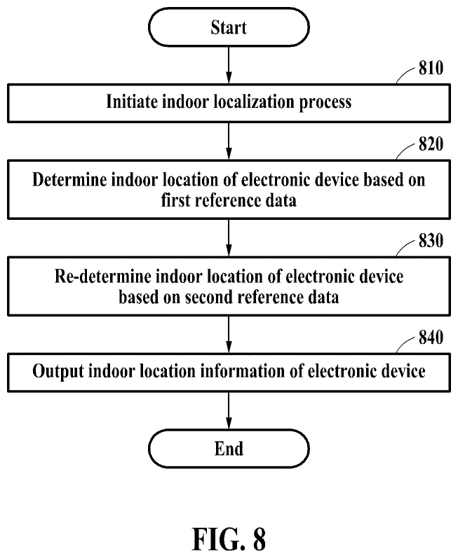

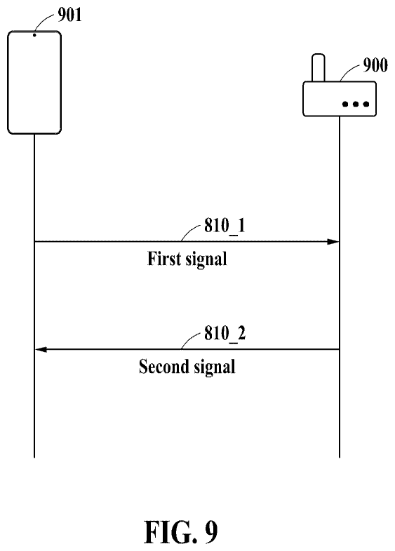

FIGS. 8 and 9 are a flowchart and signal flow diagram illustrating an example indoor localization process according to various embodiments.

Referring to FIGS. 8 and 9, according to an embodiment, an electronic device 901 (e.g., the electronic device 501 of FIG. 5) may perform an indoor localization process for detecting a current location of the electronic device 901 located in any one indoor space among a plurality of indoor spaces (e.g., the indoor spaces 51 to 59 of FIG. 5). Operations 810 to 840 may be performed sequentially, but the disclosure is not limited thereto. For example, two or more operations may be initiated in parallel. Operations 810 to 840 may be substantially identical to the operations of the electronic device 501 described with reference to FIGS. 5 and 6. Accordingly, a repeated description thereof may not be provided here.

In operation 810, the electronic device 901 may initiate the indoor localization process. For example, the electronic device 501 may execute an application for indoor localization in response to a user input.

In operation 810_1, the electronic device 901 may transmit a first signal (e.g., a probe request) for initiating the indoor localization process to an electronic device 900 (e.g., the APs 500_1 to 500_3 of FIG. 5) capable of emitting a wireless signal.

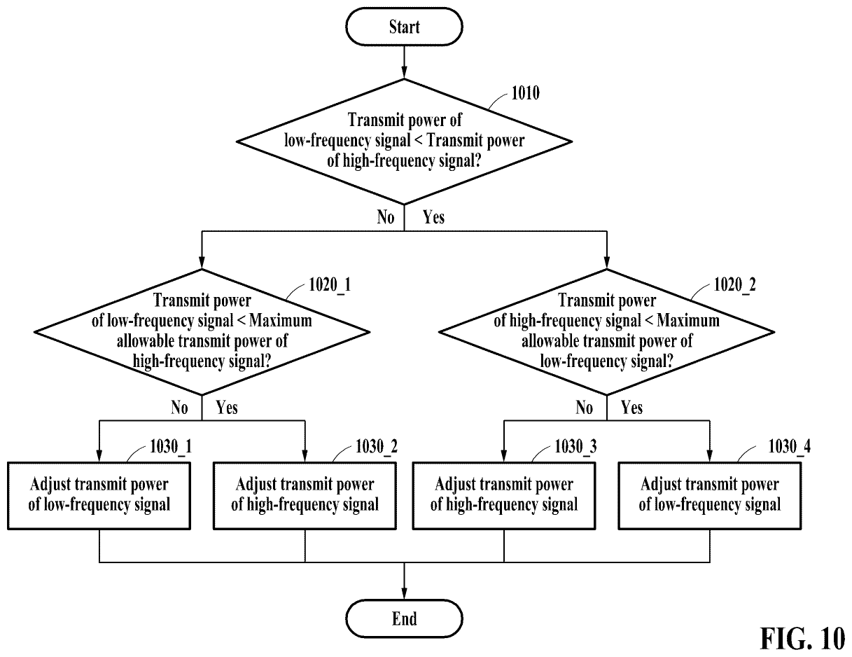

According to an embodiment, the first signal may include information for requesting the electronic device 900 to emit a wireless signal. The first signal may include transmit power information on transmit power of a high-frequency signal and transmit power of a low-frequency signal. The transmit power information may be generated based on the transmit power of the high-frequency signal and the transmit power of the low-frequency signal when reference data (e.g., the first reference data and/or the second reference data) is collected (or obtained). The station may collect the reference data after adjusting the transmit power of the high-frequency signal and the transmit power of the low-frequency signal to satisfy a predetermined condition. For example, the transmit power of the high-frequency signal and the transmit power of the low-frequency signal may be adjusted to be identical to each other. The transmit power adjustment process will be described in detail with reference to FIG. 10.

In operation 810_2, the electronic device 901 may receive a second signal (e.g., a wireless signal such as a beacon signal or an action frame) from the electronic device 900. The second signal may include a high-frequency signal (e.g., a signal in a 5 GHz band) and a low-frequency signal (e.g., a signal in a 2.4 GHz band). The electronic device 900 may adjust the transmit power of the high-frequency signal and the transmit power of the low-frequency signal based on transmit power information included in the first signal (e.g., the first signal transmitted in operation 810_1), and may emit the second signal.

In operation 820, the electronic device 901 may determine an indoor location of the electronic device 901 by obtaining an RSSI fingerprint (RSSI value) from the second signal (e.g., the second signal received in operation 810_2), and comparing the obtained RSSI fingerprint to first reference data (e.g., the first reference data obtained in operation 720 of FIG. 7).

For example, when the electronic device 901 is located in a second space 59 among a plurality of indoor spaces (e.g., the indoor spaces 51 to 59 of FIG. 5), the electronic device 901 may obtain an RSSI fingerprint from wireless signals received from APs (e.g., the APs 500_1 to 500_3 of FIG. 5). The electronic device 901 may compare the obtained RSSI fingerprint to first reference data for the first spaces 51, 53, 57, and may determine that the current location of the electronic device 901 is in any one space (e.g., the first space 57) among the first spaces based on the comparison result.

In operation 830, the electronic device 901 may re-determine the current location of the electronic device 901 (e.g., the current location of the electronic device 901 determined in operation 820) based on second reference data (e.g., the second reference data obtained in operation 730 of FIG. 7).

For example, when the current location of the electronic device 901 determined in operation 820 is the first space 57, the electronic device 901 may obtain an RSSI difference between a low-frequency signal and a high-frequency signal based on a wireless signal received from a reference device (e.g., the AP 500_3 of FIG. 5) corresponding to the first space 57. The electronic device 901 may compare the obtained RSSI difference to second reference data for the first space 57. Since the actual current location of the electronic device 901 is the second space 59 rather than the first space 57, the obtained RSSI difference may not correspond to the second reference data for the first space 57. The electronic device 901 may determine that the current indoor location of the electronic device 901 cannot be detected when the obtained RSSI difference does not correspond to the second reference data for the first space 57.

In operation 840, the electronic device 901 may output indoor location information of the electronic device 901. For example, the electronic device 901 may output a user interface configured to display the indoor location information of the electronic device 901 on a display of the electronic device 901.

FIG. 10 is a flowchart illustrating an example transmit power adjustment process according to various embodiments.

Referring to FIG. 10, according to an embodiment, in order to obtain reference data (e.g., the first reference data and/or the second reference data), a transmit power adjustment process for adjusting transmit power of a high-frequency signal and transmit power of a low-frequency signal may be performed. When the transmit power of the low-frequency signal and the transmit power of the high-frequency signal are identical to each other, an RSSI difference between the low-frequency signal and the high-frequency signal (e.g., the RSSI difference of Equation 3) may be determined based only on path loss. As the RSSI difference is less affected by elements other than path loss, accuracy of indoor localization may be improved. Operations 1010 to 1030 may be performed sequentially, but the disclosure is not limited thereto. For example, two or more operations may be performed in parallel. Operations 1010 to 1030 may be performed by a station (e.g., the station 210 of FIG. 2, the stations 310, 312 of FIG. 3) and/or an AP (e.g., the APs 200_1 to 200_3 of FIG. 2, the AP 300 of FIG. 3, the APs 500_1 to 500_3 of FIG. 5). For example, when operations 1010 to 1030 are performed by the station, the station may transmit a control signal for controlling transmit power of a low-frequency signal and a high-frequency signal to an AP. Hereinafter, it will be described assuming that operations 1010 to 1030 are performed by a station.

In operation 1010, the station may compare a set transmit power of a low-frequency signal to a set transmit power of a high-frequency signal.

In operation 1020_1, when the transmit power of the low-frequency signal is set to be greater than or equal to the transmit power of the high-frequency signal, the station may determine whether the transmit power of the low-frequency signal is set to be less than a maximum allowable transmit power of the high-frequency signal. The maximum allowable transmit power may be determined based on applicable regulations.

In operation 1020_2, when the transmit power of the low-frequency signal is set to be less than the transmit power of the high-frequency signal, the station may determine whether the transmit power of the high-frequency signal is set to be less than the maximum allowable transmit power of the low-frequency signal.

In operation 1030_1, when the transmit power of the low-frequency signal is set to be greater than or equal to the maximum allowable transmit power of the high-frequency signal, the station may adjust the transmit power of the low-frequency signal such that a difference between the transmit power of the low-frequency signal and the transmit power of the high-frequency signal becomes less than a predetermined value. For example, the station may decrease the transmit power of the low-frequency signal such that the transmit power of the low-frequency signal becomes equal to the set transmit power of the high-frequency signal.

In operation 1030_2, when the transmit power of the low-frequency signal is set to be less than the maximum allowable transmit power of the high-frequency signal, the station may adjust the transmit power of the high-frequency signal such that a difference between the transmit power of the low-frequency signal and the transmit power of the high-frequency signal becomes less than a predetermined value. For example, the station may increase the transmit power of the high-frequency signal such that the transmit power of the high-frequency signal becomes equal to the set transmit power of the low-frequency signal.

In operation 10303, when the transmit power of the high-frequency signal is set to be greater than or equal to the maximum allowable transmit power of the low-frequency signal, the station may adjust the transmit power of the high-frequency signal such that a difference between the transmit power of the low-frequency signal and the transmit power of the high-frequency signal becomes less than a predetermined value. For example, the station may decrease the transmit power of the high-frequency signal such that the transmit power of the high-frequency signal becomes equal to the set transmit power of the low-frequency signal.

In operation 1030_4, when the transmit power of the high-frequency signal is set to be less than the maximum allowable transmit power of the low-frequency signal, the station may adjust the transmit power of the low-frequency signal such that a difference between the transmit power of the low-frequency signal and the transmit power of the high-frequency signal becomes less than a predetermined value. For example, the station may increase the transmit power of the low-frequency signal such that the transmit power of the low-frequency signal becomes equal to the set transmit power of the high-frequency signal.

According to an embodiment, as the indoor localization process is performed based on reference data obtained in a state where the transmit power of the low-frequency signal and the transmit power of the high-frequency signal are controlled, indoor localization accuracy may be improved.

FIG. 11 is a diagram illustrating an example of an indoor localization system according to various embodiments.

Referring to FIG. 11, according to an embodiment, an indoor localization system 110 may include an electronic device 1101 (e.g., the electronic device 501 of FIG. 5, the electronic device 901 of FIG. 9), an AP 1100 (e.g., the APs 200_1 to 200_3 of FIG. 2, the AP 300 of FIG. 3, the APs 500_1 to 500_3 of FIG. 5), a station 1110 (e.g., the station 210 of FIG. 2, the stations 310, 312 of FIG. 3), and a station server 1105.

According to an embodiment, depending on an indoor environment, the station server 1105 may be omitted, and operations performed by the station server 1105 may be performed by the station 1110.

According to an embodiment, the AP 1100 may be replaced by a station capable of operating as a soft-AP or another electronic device capable of emitting a wireless signal (e.g., a wireless signal such as a beacon signal or an action frame).

According to an embodiment, the electronic device 1101 may perform an indoor localization process based on an RSSI of a currently received wireless signal (e.g., a high-frequency signal and a low-frequency signal) and reference data (e.g., the first reference data and the second reference data) collected in advance.

According to an embodiment, the AP 1100 may emit a wireless signal (e.g., a high-frequency signal and a low-frequency signal) when the station 1110 obtains reference data (e.g., the first reference data and the second reference data) and when the electronic device 1101 performs the indoor localization process.

According to an embodiment, the station 1110 may obtain reference data (e.g., the first reference data and the second reference data). The reference data may be transmitted to the electronic device 1101 and/or the station server 1105.

According to an embodiment, the station server 1105 may manage the station 1110. For example, the station server 1105 may receive reference data from the station 1110, and may transmit the received data to the electronic device 1101.

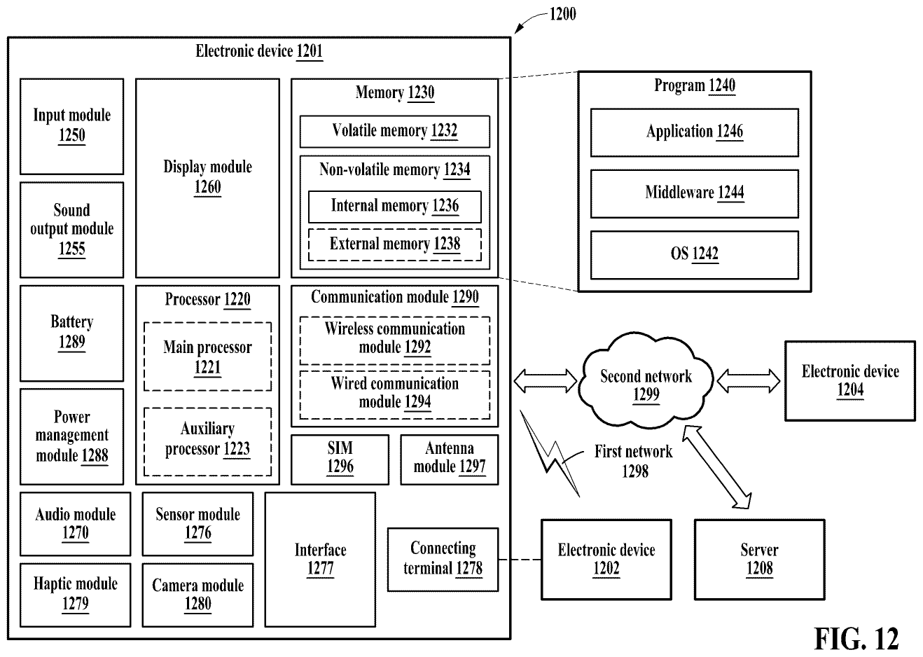

FIG. 12 is a block diagram of an example electronic device in a network environment according to various embodiments.

FIG. 12 is a block diagram illustrating an electronic device 1201 (e.g., the electronic device 501 of FIG. 5, the electronic device 901 of FIG. 9, the electronic device 1101 of FIG. 11) in a network environment 1200 according to various embodiments. Referring to FIG. 12, the electronic device 1201 in the network environment 1200 may communicate with an electronic device 1202 via a first network 1298 (e.g., a short-range wireless communication network), or communicate with at least one of an electronic device 1204 or a server 1208 via a network 1299 (e.g., a long-range wireless communication network). According to an embodiment, the electronic device 1201 may communicate with the electronic device 1204 via the server 1208. According to an embodiment, the electronic device 1201 may include a processor 1220, a memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In various embodiments, at least one of the components (e.g., the connecting terminal 1278) may be omitted from the electronic device 1201, or one or more other components may be added to the electronic device 1201. In various embodiments, some of the components (e.g., the sensor module 1276, the camera module 1280, or the antenna module 1297) may be integrated as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of data processing or computation, the processor 1220 may store a command or data received from another component (e.g., the sensor module 1276 or the communication module 1290) in a volatile memory 1232, process the command or the data stored in the volatile memory 1232, and store resulting data in a non-volatile memory 1234.

According to an embodiment, the processor 1220 may be implemented as a system on chip (SoC) or circuitry (e.g., processing circuitry) such as an integrated circuit (IC). The processor 1220 may include one or more processors. For example, the processor 1220 may include a combination of one or more processors, such as a CPU, a GPU, a micro processing unit (MPU), an AP, and a CP.

According to an embodiment, the processor 1220 may include a main processor 1221 (e.g., a central processing unit (CPU) or an application processor (AP)) or an auxiliary processor 1223 (e.g., a graphics processing unit (GPU), a neural processing unit (NPU), an image signal processor (ISP), a sensor hub processor, or a communication processor (CP)) that is operable independently of, or in conjunction with the main processor 1221. For example, when the electronic device 1201 includes the main processor 1221 and the auxiliary processor 1223, the auxiliary processor 1223 may be adapted to consume less power than the main processor 1221 or to be specific to a specified function. The auxiliary processor 1223 may be implemented separately from the main processor 1221 or as part of the main processor 1221. Thus, the processor 1220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1223 may control at least some of functions or states related to at least one (e.g., the display module 1260, the sensor module 1276, or the communication module 1290 of the components of the electronic device 1201, instead of the main processor 1221 while the main processor 1221 is in an inactive (e.g., sleep) state, or together with the main processor 1221 while the main processor 1221 is an active state (e.g., executing an application). According to an embodiment, the auxiliary processor 1223 (e.g., an ISP or a CP) may be implemented as part of another component (e.g., the camera module 1280 or the communication module 1290) functionally related to the auxiliary processor 1223. According to an embodiment, the auxiliary processor 1223 (e.g., an NPU) may include a hardware structure specified for artificial intelligence model processing. An artificial intelligence model may be generated by machine learning. Such learning may be performed, e.g., by the electronic device 1201 where the artificial intelligence is performed, or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276 of the electronic device 1201. The various data may include, for example, software (e.g., the program 1240) and input data or output data for a command related thereto.

According to an embodiment, the memory 1230 may include one or more memories. The instructions stored in the memory 1230 may be stored in one memory. The instructions stored in the memory 1230 may be divided and stored in a plurality of memories. The instructions stored in the memory 1230, when executed by the processor 1220 individually or collectively, may cause an electronic device 1202 (e.g., the electronic device 501 of FIG. 5, the electronic device 901 of FIG. 9, the electronic device 1101 of FIG. 11) to perform and/or control an indoor localization method described with reference to FIGS. 1 to 11. The instructions stored in the memory 1230, when executed by a plurality of processors individually or collectively, may cause the electronic device 1202 (e.g., the electronic device 501 of FIG. 5, the electronic device 901 of FIG. 9, the electronic device 1101 of FIG. 11) to perform and/or control the indoor localization method with reference to FIGS. 1 to 11. According to an embodiment, the memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing a record. The receiver may be used to receive incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or an external electronic device (e.g., an electronic device 1202) (e.g., a speaker or headphone) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202 directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

The connecting terminal 1278 may include a connector via which the electronic device 1201 may be physically connected with the external electronic device (e.g., the electronic device 1202). According to an embodiment, the connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image and moving images. According to an embodiment, the camera module 1280 may include one or more lenses, image sensors, ISPs, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more CPs that are operable independently from the processor 1220 (e.g., the AP) and support a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device 1204 via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the SIM 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element including a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to an embodiment, the antenna module 1297 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the external electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, cloud computing, distributed computing, mobile edge computing (MEC), or client-server computing technology may be used, for example. The electronic device 1201 may provide ultra low-latency services using, e.g., distributed computing or mobile edge computing. In an embodiment, the external electronic device 1204 may include an Internet-of-Things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

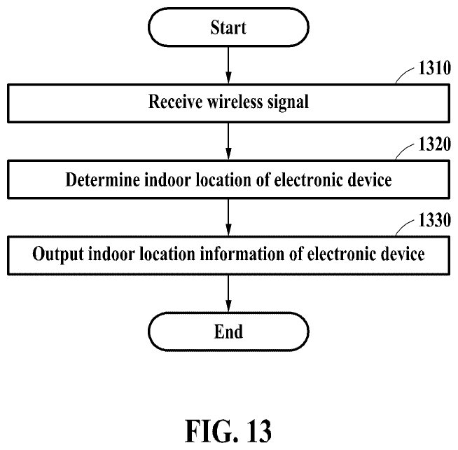

FIG. 13 is a flowchart illustrating an example operation of an electronic device according to various embodiments.

Referring to FIG. 13, according to an embodiment, operations 1310 to 1330 may be sequentially performed but are not limited thereto. For example, two or more operations may be performed in parallel. Operations 1310 to 1330 may be substantially identical to operations of an electronic device (e.g., the electronic device 501 of FIG. 5, the electronic device 901 of FIG. 9, the electronic device 1101 of FIG. 11, the electronic device 1201 of FIG. 12) described with reference to FIGS. 5 to 12. Accordingly, a repeated description thereof will be omitted.

In operation 1310, the electronic device 501, 901, 1101, 1201 may receive a wireless signal from an external electronic device (e.g., the APs 500_1 to 500_3 of FIG. 5, the AP 900 of FIG. 9, the AP 1100 of FIG. 11). The wireless signal may include a first frequency signal (e.g., a low-frequency signal) and a second frequency signal (e.g., a high-frequency signal).

In operation 1320, the electronic device 501, 901, 1101, 1201 may determine an indoor location of the electronic device 501, 901, 1101, 1201 based on an RSSI of the received wireless signal and first reference data. For example, the electronic device 501, 901, 1101, 1201 may determine that the electronic device 501, 901, 1101, 1201 is located in a specific indoor space (e.g., the second space 55 of FIG. 5).

In operation 1330, the electronic device 501, 901, 1101, 1201 may re-determine the current location of the electronic device 501, 901, 1101, 1201 based on an RSSI difference between the first frequency signal and the second frequency signal and second reference data, and may output indoor location information of the electronic device 501, 901, 1101, 1201, in response to determining that the electronic device 501, 901, 1101, 1201 is located in a specific indoor space.

An electronic device 501, 901, 1101, 1201 according to an example embodiment may include a processor 1220, and memory 1230 storing instructions. The instructions, when executed by the processor 1220 individually and/or collectively, may cause the electronic device 501, 901, 1101, 1201 to receive a wireless signal including a first frequency signal and a second frequency signal from an external electronic device 5001, 500_2, 5003, 900, 1100. The instructions, when executed by the processor 1220 individually and/or collectively, may cause the electronic device 501, 901, 1101, 1201 to determine that the electronic device 501, 901, 1101, 1201 is located in a specific indoor space based on an RSSI of the wireless signal and first reference data. The instructions, when executed by the processor 1220 individually and/or collectively, may cause the electronic device 501, 901, 1101, 1201 to output indoor location information of the electronic device 501, 901, 1101, 1201 based on an RSSI difference between the first frequency signal and the second frequency signal and second reference data, in response to determining that the electronic device 501, 901, 1101, 1201 is located in the specific indoor space.

The frequency of the first frequency signal may be lower than the frequency of the second frequency signal.

The first reference data may include RSSI fingerprint information for one or more indoor spaces 51, 53, 57 among a plurality of indoor spaces 51, 53, 55, 57, 59 around the electronic device 501, 901, 1101, 1201.

The second reference data may include RSSI difference information between a third frequency signal and a fourth frequency signal for the one or more indoor spaces 51, 53, 57.

The third frequency signal may correspond to the first frequency signal. The fourth frequency signal may correspond to the second frequency signal.

The instructions, when executed by the processor 1220 individually and/or collectively, may cause the electronic device 501, 901, 1101, 1201 to output a user interface displaying an indoor location of the electronic device 501, 901, 1101, 1201 based on a maximum difference value included in RSSI difference information for the specific indoor space and the RSSI difference.

The instructions, when executed by the processor 1220 individually and/or collectively, may cause the electronic device 501, 901, 1101, 1201 to output a user interface indicating that an indoor location of the electronic device 501, 901, 1101, 1201 cannot be determined when the RSSI difference is greater than the maximum difference value.

The second reference data may be generated based on a wireless signal received from an external electronic device 5001, 500_2, 5003, 900, 1100 corresponding to each of the one or more indoor spaces 51, 53, 57.

The second reference data may be obtained when a difference between transmit power of the third frequency signal and transmit power of the fourth frequency signal is less than a predetermined value.

The instructions, when executed by the processor 1220 individually and/or collectively, may further cause the electronic device 501, 901, 1101, 1201 to transmit a signal to the external electronic device 500_1, 500_2, 5003, 900, 1100 for initiating an indoor localization process by the electronic device 501, 901, 1101, 1201. The signal may include information on the transmit power of the third frequency signal and the transmit power of the fourth frequency signal.

A method of operating an electronic device 501, 901, 1101, 1201 according to an example embodiment may include receiving a wireless signal including a first frequency signal and a second frequency signal from an external electronic device 5001, 500_2, 5003, 900, 1100. The method may include determining that the electronic device 501, 901, 1101, 1201 is located in a specific indoor space based on an RSSI of the wireless signal and first reference data. The method may include outputting indoor location information of the electronic device 501, 901, 1101, 1201 based on an RSSI difference between the first frequency signal and the second frequency signal and second reference data, in response to determining that the electronic device 501, 901, 1101, 1201 is located in the specific indoor space.

The frequency of the first frequency signal may be lower than the frequency of the second frequency signal.

The first reference data may include RSSI fingerprint information for one or more indoor spaces 51, 53, 57 among a plurality of indoor spaces 51, 53, 55, 57, 59 around the electronic device 501, 901, 1101, 1201.

The second reference data may include RSSI difference information between a third frequency signal and a fourth frequency signal for the one or more indoor spaces 51, 53, 57.

The third frequency signal may correspond to the first frequency signal. The fourth frequency signal may correspond to the second frequency signal.

The outputting may include outputting a user interface displaying an indoor location of the electronic device 501, 901, 1101, 1201 based on a maximum difference value included in RSSI difference information for the specific indoor space and the RSSI difference.

The outputting of the user interface may include outputting a user interface indicating that an indoor location of the electronic device 501, 901, 1101, 1201 cannot be determined when the RSSI difference is greater than the maximum difference value.

The second reference data may be generated based on a wireless signal received from an external electronic device 5001, 500_2, 5003, 900, 1100 corresponding to each of the one or more indoor spaces 51, 53, 57.

The second reference data may be obtained when a difference between transmit power of the third frequency signal and transmit power of the fourth frequency signal is less than a predetermined value.

The method may further include transmitting a signal to the external electronic device 5001, 500_2, 5003, 900, 1100 for initiating an indoor localization process by the electronic device 501, 901, 1101, 1201. The signal may include information on the transmit power of the third frequency signal and the transmit power of the fourth frequency signal.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
at least one processor comprising processing circuitry; and
memory storing instructions,
wherein at least one processor, individually and/or collectively, is configured to execute the instructions and to cause the electronic device to:
receive a wireless signal including a first frequency signal and a second frequency signal from an external electronic device;
determine that the electronic device is located in an indoor space based on a received signal strength indicator (RSSI) of the wireless signal and first reference data; and
output indoor location information of the electronic device based on an RSSI difference between the first frequency signal and the second frequency signal and second reference data, in response to determining that the electronic device is located in the indoor space.

2. The electronic device of claim 1, wherein a frequency of the first frequency signal is lower than a frequency of the second frequency signal.

3. The electronic device of claim 1, wherein the first reference data comprises RSSI fingerprint information for one or more indoor spaces among a plurality of indoor spaces within a specified range of the electronic device.

4. The electronic device of claim 3, wherein the second reference data comprises RSSI difference information between a third frequency signal and a fourth frequency signal for the one or more indoor spaces.

5. The electronic device of claim 4, wherein the third frequency signal corresponds to the first frequency signal, and the fourth frequency signal corresponds to the second frequency signal.

6. The electronic device of claim 4, wherein at least one processor, individually and/or collectively, is configured to cause the electronic device to output a user interface displaying an indoor location of the electronic device based on a maximum difference value included in RSSI difference information for the indoor space and the RSSI difference.

7. The electronic device of claim 6, wherein at least one processor, individually and/or collectively, is configured to cause the electronic device to output a user interface indicating that an indoor location of the electronic device cannot be determined based on the RSSI difference being greater than the maximum difference value.

8. The electronic device of claim 4, wherein the second reference data is configured to be generated based on a wireless signal received from an external electronic device corresponding to each of the one or more indoor spaces.

9. The electronic device of claim 5, wherein the second reference data is configured to be obtained based on a difference between transmit power of the third frequency signal and transmit power of the fourth frequency signal being less than a specified value.

10. The electronic device of claim 9, wherein at least one processor, individually and/or collectively, is configured to cause the electronic device to: transmit a signal to the external electronic device to initiate an indoor localization process by the electronic device, and
wherein the signal comprises information on the transmit power of the third frequency signal and the transmit power of the fourth frequency signal.

11. A method of operating an electronic device, the method comprising:
receiving a wireless signal including a first frequency signal and a second frequency signal from an external electronic device;
determining that the electronic device is located in an indoor space based on a received signal strength indicator (RSSI) of the wireless signal and first reference data; and
outputting indoor location information of the electronic device based on an RSSI difference between the first frequency signal and the second frequency signal and second reference data, in response to determining that the electronic device is located in the indoor space.

12. The method of claim 11, wherein a frequency of the first frequency signal is lower than a frequency of the second frequency signal.

13. The method of claim 11, wherein the first reference data comprises RSSI fingerprint information for one or more indoor spaces among a plurality of indoor spaces within a specified range of the electronic device.

14. The method of claim 13, wherein the second reference data comprises RSSI difference information between a third frequency signal and a fourth frequency signal for the one or more indoor spaces.

15. The method of claim 14, wherein the third frequency signal corresponds to the first frequency signal, and the fourth frequency signal corresponds to the second frequency signal.

16. The method of claim 14, wherein the outputting comprises outputting a user interface displaying an indoor location of the electronic device based on a maximum difference value included in RSSI difference information for the indoor space and the RSSI difference.

17. The method of claim 16, wherein the outputting the user interface comprises outputting a user interface indicating that an indoor location of the electronic device cannot be determined based on the RSSI difference being greater than the maximum difference value.

18. The method of claim 14, wherein the second reference data is generated based on a wireless signal received from an external electronic device corresponding to each of the one or more indoor spaces.

19. The method of claim 15, wherein the second reference data is obtained based on a difference between transmit power of the third frequency signal and transmit power of the fourth frequency signal being less than a specified value.

20. The method of claim 19, further comprising transmitting a signal to the external electronic device to initiate an indoor localization process by the electronic device,
wherein the signal comprises information on the transmit power of the third frequency signal and the transmit power of the fourth frequency signal.
